(19) United States
(12) Patent Application Publication
(10) Pub. No.: US 2011/0033699 A1
(43) Pub. Date: Feb. 10, 2011

(54) PRESSURE-SENSITIVE ADHESIVE TAPE

(75) Inventors: Naoto HAYASHI, Ibaraki-shi (JP); Shinsuke Ikishima, Ibaraki-shi (JP); Kooki Ooyama, Ibaraki-shi (JP); Keiji Hayashi, Ibaraki-shi (JP); Shou Uchida, Ibaraki-shi (JP); Kouhei Takeda, Ibaraki-shi (JP); Ikkou Hanaki, Ibaraki-shi (JP)

Correspondence Address: SUGHRUE MION, PLLC, 2100 PENNSYLVANIA AVENUE, N.W., SUITE 800, WASHINGTON, DC, 20037, US

(73) Assignee: NITTO DENKO CORPORATION, Osaka (JP)

(21) Appl. No.: 12/836,337

(22) Filed: Jul. 14, 2010

(30) Foreign Application Priority Data
Jul. 23, 2009 (JP) 2009-172144
Jul. 23, 2009 (JP) 2009-172145
Mar. 24, 2010 (JP) 2010-067743
Mar. 24, 2010 (JP) 2010-067746

(51) Int. Cl. C09J 7/02

(52) U.S. Cl. 428/352; 428/354

(57) ABSTRACT

Provided is such a pressure-sensitive adhesive tape as described below, which is capable of protecting the uneven surface of a member having unevenness on its surface. The pressure-sensitive adhesive tape brings together sufficient pressure-sensitive adhesiveness for, and sufficient releasability from, the member. In addition, even upon deformation of the member protected with the pressure-sensitive adhesive tape by, for example, lamination or continuous winding, the uneven shape does not deform and a base material layer in the pressure-sensitive adhesive tape is not damaged. Also provided is a pressure-sensitive adhesive tape useful as such a surface protective film for a prism sheet as described below, which is capable of effectively protecting, for example, a lens surface of a prism sheet having multiple triangle pole-shaped prisms fixed on its surface. The surface protective film brings together sufficient pressure-sensitive adhesiveness for, and sufficient releasability from, the prism sheet. In addition, when the prism sheet protected with the surface protective film is brought into a state such as a laminated state or a continuously wound state, the emergence of irregularity (indentation) in the external appearance of the prism sheet to which the surface protective film is attached can be suppressed. A pressure-sensitive adhesive tape of the present invention is a pressure-sensitive adhesive tape including a base material layer, a first pressure-sensitive adhesive layer, and a second pressure-sensitive adhesive layer in the stated order, in which: the base material layer contains a thermoplastic resin; the storage modulus of the first pressure-sensitive adhesive layer is higher than the storage modulus of the second pressure-sensitive adhesive layer; and a difference between the storage modulus of the first pressure-sensitive adhesive layer at a frequency of 10 Hz and 23° C., and the storage modulus of the second pressure-sensitive adhesive layer at a frequency of 10 Hz and 23° C. is 3×10⁵ Pa or more.

### TECHNICAL FIELD

The present invention relates to a pressure-sensitive adhesive tape, and more specifically, to a pressure-sensitive adhesive tape capable of effectively protecting the uneven surface of a member having unevenness on its surface. A pressure-sensitive adhesive tape of the present invention is particularly useful as a surface protective film for uneven members each provided with design by forming unevenness on its surface, the uneven members being used in the fields of, for example, automobiles and housing construction materials, or a surface protective film capable of effectively protecting a lens surface of a prism sheet having multiple triangle pole-shaped prisms fixed on its surface.

### BACKGROUND ART

In general, pressure-sensitive adhesive tapes in each of which a pressure-sensitive adhesive layer is laminated on one surface of a film-shaped base material layer have been widely used for protecting the surfaces of assorted adherends.

Meanwhile, a large number of members each having unevenness formed on its surface exist for the purposes of imparting design, handling property, optical functionality, and the like. Any such member having unevenness formed on its surface involves the following problem. That is, dirt adheres to uneven portions or a convex portion is flawed. Any such pressure-sensitive adhesive tape as described above is used for preventing such problem.

Such pressure-sensitive adhesive tape needs to have such adhesion as not to be released during the protection of a member having unevenness formed on its surface. To that end, the pressure-sensitive adhesive tape must be provided with high adhesion by using a flexible pressure-sensitive adhesive in the pressure-sensitive adhesive layer. However, the use of the flexible pressure-sensitive adhesive in the pressure-sensitive adhesive layer involves the emergence of the following problem. That is, uneven apexes in the member having unevenness formed on its surface as an adherend penetrate the pressure-sensitive adhesive layer to reach the base material layer, and hence the uneven apexes are deformed.

On the other hand, when the adhesion between the member having unevenness formed on its surface and the pressure-sensitive adhesive tape is excessively strong, the following problem arises. That is, smooth release cannot be achieved upon release of the pressure-sensitive adhesive tape from the member having unevenness formed on its surface.

Therefore, the pressure-sensitive adhesive layer of the pressure-sensitive adhesive tape to be used for the protection of the member having unevenness formed on its surface must have such hardness that the uneven apexes do not reach the base material layer of the pressure-sensitive adhesive tape upon protection as well as mutually contradictory properties, i.e., pressure-sensitive adhesiveness and releasability.

A pressure-sensitive adhesive tape using a pressure-sensitive adhesive layer mainly formed of a styrene-based elastomer and having a thickness of 10 μm or less has been disclosed as a pressure-sensitive adhesive tape having a special pressure-sensitive adhesive layer (for example, Japanese Patent Application Laid-open No. 2007-332329).

However, the pressure-sensitive adhesive tape disclosed in Japanese Patent Application Laid-open No. 2007-332329 involves the emergence of the following problem. That is, when the tape is used for protecting the surface of a member having unevenness formed on its surface, uneven apexes penetrate the pressure-sensitive adhesive layer to reach the base material layer, and hence the uneven apexes are deformed. In addition, the pressure-sensitive adhesive tape disclosed in Japanese Patent Application Laid-open No. 2007-332329 involves the emergence of the following problem. That is, depending on the selection of a material for the tape, the tape does not have sufficient adhesion and is hence naturally released from the adherend, or the tape has so strong adhesion that the tape cannot be smoothly released from the adherend.

In addition, in general, surface protective films in each of which a pressure-sensitive adhesive layer is laminated on one surface of a film-shaped base material layer have been widely used for protecting the surfaces of assorted adherends.

On the other hand, prism sheets each having multiple triangle pole-shaped prisms fixed on the sheet surface have been used in assorted optical devices. In any such prism sheet, the following problem arises. That is, dirt adheres to a lens surface (prism surface) or a lens portion (prism portion) is flawed. Any such surface protective film as described above is used for preventing such problem.

A surface protective film for protecting the surface of a prism sheet needs to have such stable adhesion that the film is not released during the protection and can be smoothly released upon release when the protection is no longer needed. In addition, upon protection of the prism sheet with such surface protective film, a precisely formed prism pattern must not be subjected to any optical adverse effect.

Heretofore, a rubber-based pressure-sensitive adhesive has been generally used as a pressure-sensitive adhesive in a surface protective film for an optical member such as a prism sheet (for example, Japanese Patent Application Laid-open No. Hei 11-181370).

Meanwhile, a prism sheet to which a surface protective film is attached is transferred between steps in, for example, a laminated state or a continuously wound state. When the prism sheet is, for example, laminated as described above, lens portions (prism portions) of the prism sheet may deeply indent the surface protective film in an irregular fashion owing to the self weight of the prism sheet. When irregularity (indentation) emerges in the external appearance of the prism sheet to which the surface protective film is attached as described above, it becomes difficult to inspect the external appearance of the prism sheet in a state where the surface protective film is attached.

### SUMMARY OF INVENTION

### Technical Problem

The present invention has been made to solve the above-mentioned conventional problems, and an object of the present invention is to provide such a pressure-sensitive adhesive tape as described below, which is capable of protecting the uneven surface of a member having unevenness on its surface. The pressure-sensitive adhesive tape brings together sufficient pressure-sensitive adhesiveness for, and sufficient releasability from, the member. In addition, even upon deformation of the member protected with the pressure-sensitive adhesive tape by, for example, lamination or continuous winding, the uneven shape does not deform and a base material layer in the pressure-sensitive adhesive tape is not damaged. Another object of the present invention is to provide a pressure-sensitive adhesive tape useful as such a surface protective film for a prism sheet as described below, which is capable of effectively protecting, for example, a lens surface of a prism sheet having multiple triangle pole-shaped prisms fixed on its surface. The surface protective film brings together sufficient pressure-sensitive adhesiveness for, and sufficient releasability from, the prism sheet. In addition, when the prism sheet protected with the surface protective film is brought into a state such as a laminated state or a continuously wound state, the emergence of irregularity (indentation) in the external appearance of the prism sheet to which the surface protective film is attached can be suppressed.

### Solution to Problem

A pressure-sensitive adhesive tape of the present invention is a pressure-sensitive adhesive tape including a base material layer, a first pressure-sensitive adhesive layer, and a second pressure-sensitive adhesive layer in the stated order, in which the base material layer contains a thermoplastic resin; the storage modulus of the first pressure-sensitive adhesive layer is higher than the storage modulus of the second pressure-sensitive adhesive layer; and a difference between the storage modulus of the first pressure-sensitive adhesive layer at a frequency of 10 Hz and 23° C., and the storage modulus of the second pressure-sensitive adhesive layer at a frequency of 10 Hz and 23° C. is 3×10⁵ Pa or more.

In a preferred embodiment, the above-mentioned first pressure-sensitive adhesive layer has a storage modulus of 1.0×10⁶ Pa or more and less than 1.0×10⁹ Pa at a frequency of 10 Hz and 23° C.

In a preferred embodiment, the above-mentioned second pressure-sensitive adhesive layer has a storage modulus of 1.0×10³ Pa or more and less than 1.0×10⁶ Pa at a frequency of 10 Hz and 23° C.

In a preferred embodiment, a releasing layer is placed on a side of the above-mentioned base material layer opposite to the above-mentioned first pressure-sensitive adhesive layer and the above-mentioned second pressure-sensitive adhesive layer.

In a preferred embodiment, the pressure-sensitive adhesive tape of the present invention is a surface protective film for a prism sheet.

### ADVANTAGEOUS EFFECTS OF INVENTION

According to the present invention, there can be provided such a pressure-sensitive adhesive tape as described below, which is capable of protecting the uneven surface of a member having unevenness on its surface. The pressure-sensitive adhesive tape brings together sufficient pressure-sensitive adhesiveness for, and sufficient releasability from, the member. In addition, even upon deformation of the member protected with the pressure-sensitive adhesive tape by, for example, lamination or continuous winding, the uneven shape does not deform and a base material layer in the pressure-sensitive adhesive tape is not damaged. There can also be provided a pressure-sensitive adhesive tape useful as such a surface protective film for a prism sheet as described below, which is capable of effectively protecting, for example, a lens surface of a prism sheet having multiple triangle pole-shaped prisms fixed on its surface. The surface protective film brings together sufficient pressure-sensitive adhesiveness for, and sufficient releasability from, the prism sheet. In addition, when the prism sheet protected with the surface protective film is brought into a state such as a laminated state or a continuously wound state, the emergence of irregularity (indentation) in the external appearance of the prism sheet to which the surface protective film is attached can be suppressed.

### BRIEF DESCRIPTION OF DRAWINGS

FIG. 1 is a schematic sectional view of a pressure-sensitive adhesive tape according to a preferred embodiment of the present invention.

FIG. 2 is a schematic sectional view illustrating a state where the pressure-sensitive adhesive tape of the present invention is attached as a surface protective film for a prism sheet to a prism sheet.

### DESCRIPTION OF EMBODIMENTS

### A. Pressure-Sensitive Adhesive Tape

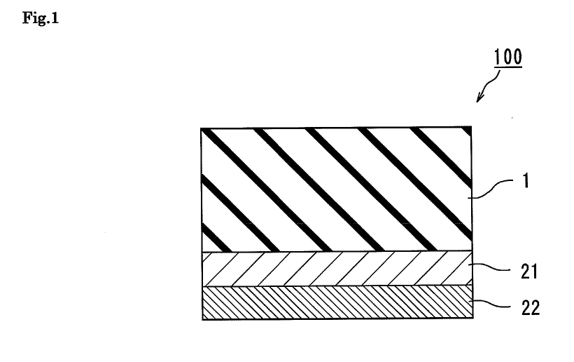

A pressure-sensitive adhesive tape of the present invention has a base material layer, a first pressure-sensitive adhesive layer, and a second pressure-sensitive adhesive layer in the stated order. FIG. 1 is a schematic sectional view of the pressure-sensitive adhesive tape according to a preferred embodiment of the present invention. A pressure-sensitive adhesive tape 100 includes a base material layer 1, a first pressure-sensitive adhesive layer 21 placed on one side, or each of both sides, of the base material layer 1 (one side in the illustrated example), and a second pressure-sensitive adhesive layer 22 placed on the side of the first pressure-sensitive adhesive layer 21 opposite to the base material layer 1. The pressure-sensitive adhesive tape of the present invention may further have any appropriate other layer (not illustrated) as required.

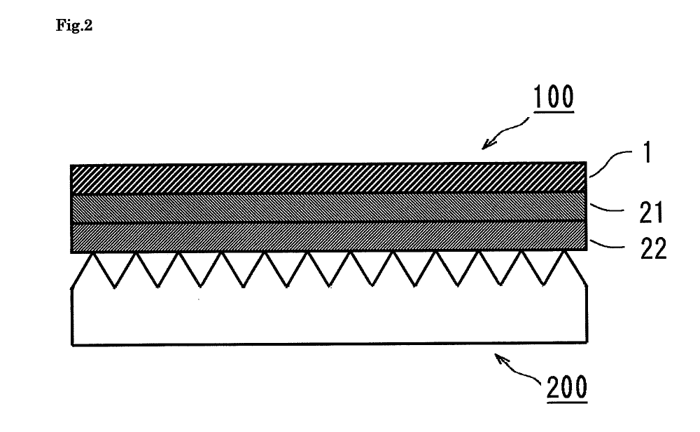

FIG. 2 is a schematic sectional view illustrating a state where the pressure-sensitive adhesive tape of the present invention is attached as a surface protective film for a prism sheet to a prism sheet. The pressure-sensitive adhesive tape 100 as a surface protective film for a prism sheet is attached to a prism sheet 200 with the second pressure-sensitive adhesive layer 22.

The thickness of the pressure-sensitive adhesive tape of the present invention can be set to any appropriate thickness depending on applications. The thickness is representatively 15 μm to 450 μm.

The pressure-sensitive adhesive tape of the present invention may be such that a releasing layer is placed on the side of the above-mentioned base material layer opposite to the above-mentioned first pressure-sensitive adhesive layer and the above-mentioned second pressure-sensitive adhesive layer.

### A-1. Base Material Layer

Any appropriate thickness can be adopted as the thickness of the above-mentioned base material layer, depending on applications. The thickness of the above-mentioned base material layer is preferably 10 μm to 150 μm, or more preferably 20 μm to 100 μm.

Any appropriate value can be adopted as the haze value of the above-mentioned base material layer.

The above-mentioned base material layer contains a thermoplastic resin. Any appropriate resin can be adopted as the above-mentioned thermoplastic resin as long as film forming by melt extrusion can be performed.

Examples of the above-mentioned thermoplastic resin include: polyolefin resins such as a propylene-based polymer, a polyethylene, and an olefin-based thermoplastic elastomer (TPO) and modified products thereof; α-olefin-vinyl compound (such as vinyl acetate and (meth)acrylic acid ester) copolymers; polyamides; polyesters; polycarbonates; polyurethanes; and polyvinyl chlorides. Examples of the propylene-based polymer include a homopolypropylene, a block polypropylene, and a random polypropylene.

When a homopolypropylene is used as the above-mentioned thermoplastic resin, the structure of the homopolypropylene may be any one of an isotactic structure, an atactic structure, and a syndiotactic structure.

When a polyethylene is used as the above-mentioned thermoplastic resin, the polyethylene may be any one of a low-density polyethylene, a medium-density polyethylene, and a high-density polyethylene.

In the above-mentioned base material layer, one kind of the above-mentioned thermoplastic resins may be used alone, or two or more kinds of them may be used in combination. When two or more kinds of the resins are used in combination, the resins may be blended, or may be copolymerized.

A commercially available product may be used as the above-mentioned thermoplastic resin. A specific example of the commercially available thermoplastic resin is a product available under the trade name “PF380A” (block polypropylene) from SunAllomer Ltd.

The above-mentioned base material layer can contain any appropriate additive as required. Examples of the additive that can be incorporated into the base material layer include a UV absorbing agent, a thermal stabilizer, a filler, and a lubricant. The kinds, number, and amount of additives to be incorporated into the above-mentioned base material layer can be appropriately set depending on purposes.

Examples of the above-mentioned UV absorbing agent include a benzotriazole-based compound, a benzophenone-based compound, and a benzoate-based compound. Any appropriate content can be adopted as the content of the above-mentioned UV absorbing agent as long as the agent does not bleed out at the time of the forming of the laminated film. The content is representatively 0.01 part by weight to 5 parts by weight with respect to 100 parts by weight of the thermoplastic resin in the base material layer.

Examples of the above-mentioned thermal stabilizer include a hindered amine-based compound, a phosphorus-based compound, and a cyanoacrylate-based compound. Any appropriate content can be adopted as the content of the above-mentioned thermal stabilizer as long as the stabilizer does not bleed out at the time of the forming of the laminated film. The content is representatively 0.01 part by weight to 5 parts by weight with respect to 100 parts by weight of the thermoplastic resin in the base material layer.

Examples of the above-mentioned filler include inorganic fillers such as talc, titanium oxide, calcium carbonate, clay, mica, barium sulfate, whisker, and magnesium hydroxide. The filler preferably has an average particle diameter of 0.1 μm to 10 μm. The content of the filler is preferably 1 part by weight to 200 parts by weight with respect to 100 parts by weight of the thermoplastic resin in the base material layer.

### A-2. First Pressure-Sensitive Adhesive Layer and Second Pressure-Sensitive Adhesive Layer

The above-mentioned first pressure-sensitive adhesive layer and the above-mentioned second pressure-sensitive adhesive layer each have a thickness of preferably 1 μm to 300 μm, more preferably 1 μm to 100 μm, or particularly preferably 1 μm to 50 μm.

Any appropriate value can be adopted as the haze value of each of the above-mentioned first pressure-sensitive adhesive layer and the above-mentioned second pressure-sensitive adhesive layer.

Any appropriate pressure-sensitive adhesive can be adopted as a pressure-sensitive adhesive of which each of the above-mentioned first pressure-sensitive adhesive layer and the above-mentioned second pressure-sensitive adhesive layer is constituted. Examples of the above-mentioned pressure-sensitive adhesive include a rubber-based pressure-sensitive adhesive, an acrylic pressure-sensitive adhesive, and a silicone-based pressure-sensitive adhesive.

A thermoplastic pressure-sensitive adhesive can also be used as the above-mentioned pressure-sensitive adhesive. With regard to a material of which the thermoplastic pressure-sensitive adhesive is constituted, a pressure-sensitive adhesive material is, for example, any appropriate styrene-based block copolymer or acrylic thermoplastic resin.

Specific examples of the above-mentioned styrene-based block copolymer include: styrene-based AB-type diblock copolymers such as a styrene-ethylene-butylene copolymer (SEB); styrene-based ABA-type triblock copolymers such as a styrene-butadiene-styrene copolymer (SBS), a hydrogen additive of SBS (styrene-ethylene-butylene-styrene copolymer (SEBS)), a styrene-isoprene-styrene copolymer (SIS), a hydrogen additive of SIS (styrene-ethylene-propylene-styrene copolymer (SEPS)), a styrene-isobutylene-styrene copolymer (SIBS); styrene-based ABAB-type tetrablock copolymers such as a styrene-butadiene-styrene-butadiene copolymer (SBSB); styrene-based ABABA-type pentablock copolymers such as a styrene-butadiene-styrene-butadiene-styrene copolymer (SBSBS); styrene-based multi block copolymers having six or more of A-B repeated units; and hydrogen additives in which a styrene-based random copolymer such as a styrene-butadiene rubber (SBR) having an ethylene double bond is hydrogenated. Examples of commercially available products include “Tuftec H1062,” “Tuftec H1041,” and “Tuftec H1221” (styrene-based elastomer) each manufactured by Asahi Kasei Chemicals Corporation., “DYNARON 1320P” (styrene-based elastomer) manufactured by JSR Corporation, and “G1657” (styrene-based elastomer) manufactured by Kraton Polymers. One kind of the above-mentioned copolymers may be used alone, or two or more kinds of them may be used in combination.

The content of a styrene block structure in the above-mentioned styrene-based block copolymer is preferably 5 wt % to 40 wt %, more preferably 7 wt % to 35 wt %, or particularly preferably 9 wt % to 30 wt %. When the content of the styrene block structure is smaller than 5 wt %, an adhesive residue is apt to be generated owing to an insufficient cohesive strength of the pressure-sensitive adhesive layer (the above-mentioned first pressure-sensitive adhesive layer and the above-mentioned second pressure-sensitive adhesive layer). When the content of the styrene block structure is larger than 40 wt %, the pressure-sensitive adhesive layer (the above-mentioned first pressure-sensitive adhesive layer and the above-mentioned second pressure-sensitive adhesive layer) becomes hard, and good adhesion for a rough surface may not be obtained.

When the above-mentioned styrene-based block copolymer has an ethylene-butylene block structure, the content of a constituent unit derived from butylene in the ethylene-butylene block structure is preferably 50 wt % or more, more preferably 60 wt % or more, particularly preferably 70 wt % or more, or most preferably 70 wt % to 90 wt %. When the content of the constituent unit derived from butylene falls within such range, a pressure-sensitive adhesive layer (the above-mentioned first pressure-sensitive adhesive layer and the above-mentioned second pressure-sensitive adhesive layer) excellent in wettability and adhesion, and are capable of favorably bonding even to a rough surface can be obtained.

Examples of the above-mentioned acrylic thermoplastic resin include: a polymethyl methacrylate-polybutyl acrylate-polymethyl methacrylate copolymer (PMMA-PBA-PMMA copolymer); and a PMMA-functional group-containing PBA-PMMA copolymer of such a type that the polybutyl acrylate has a carboxylic acid as a functional group. A commercially available product may be used as the acrylic thermoplastic resin. Specific examples of the commercially available acrylic thermoplastic resin include a product available under the trade name “NABSTAR” from KANEKA CORPORATION and a product available under the trade name “LA Polymer” from KURARAY CO., LTD.

The above-mentioned first pressure-sensitive adhesive layer and the above-mentioned second pressure-sensitive adhesive layer can each contain any other component as required. Examples of the other component include: an olefin-based resin; a silicone-based resin; a liquid acrylic copolymer; a polyethyleneimine; a fatty acid amide; a phosphate; and a general additive. The kinds, number, and amount of the above-mentioned other components can be appropriately set depending on purposes. Examples of the above-mentioned additive include: a tackifier; a softening agent; an antioxidant; a hindered amine-based light stabilizer; a UV absorbing agent; a thermal stabilizer; and a filler or pigment such as calcium oxide, magnesium oxide, silica, zinc oxide, or titanium oxide.

The compounding of the tackifier is effective in improving an adhesive strength. The compounding amount of the tackifier is suitably determined to be any appropriate compounding amount depending on an adherend in order that the emergence of an adhesive residue problem due to a reduction in cohesive strength may be avoided. In ordinary cases, the amount is preferably 0 to 40 parts by weight, more preferably 0 to 30 parts by weight, or still more preferably 0 to 10 parts by weight with respect to 100 parts by weight of the pressure-sensitive adhesive contained in the above-mentioned first pressure-sensitive adhesive layer or the above-mentioned second pressure-sensitive adhesive layer.

Examples of the tackifier include: petroleum-based resins such as an aliphatic copolymer, an aromatic copolymer, an aliphatic/aromatic copolymer system, and an alicyclic copolymer; rosin-based resins such as a coumarone-indene-based resin, a terpene-based resin, a terpene phenol-based resin, and polymerized rosin; (alkyl) phenol-based resins; xylene-based resins; and hydrogenated products of the resins. One kind of the tackifiers may be used alone, or two or more kinds of them may be used in combination.

A hydrogenated tackifier such as an “ARCON P-125” manufactured by Arakawa Chemical Industries, Ltd. is preferably used as the tackifier in terms of, for example, releasability and weatherability. It should be noted that a product commercially available as a blend with an olefin resin or thermoplastic elastomer can also be used as the tackifier.

The compounding of the softening agent is effective in improving the adhesive strength. Examples of the softening agent include a low-molecular-weight diene-based polymer, a polyisobutylene, a hydrogenated polyisoprene, a hydrogenated polybutadiene, and derivatives of them. Examples of the derivatives include those each having an OH group or COOH group on one of, or each of both of, its terminals. Specific examples of such derivatives include a hydrogenated polybutadiene diol, a hydrogenated polybutadiene monool, a hydrogenated polyisoprene diol, and a hydrogenated polyisoprene monool. A hydrogenated product of a diene-based polymer such as a hydrogenated polybutadiene or a hydrogenated polyisoprene, an olefin-based softening agent, or the like is preferred in order that a rise in adhesion for the adherend may be additionally suppressed. To be specific, a “Kuraprene LIR-200” manufactured by KURARAY CO., LTD. is exemplified. One kind of those softening agents may be used alone, or two or more kinds of them may be used in combination.

The molecular weight of the softening agent can be suitably set to any appropriate value. When the molecular weight of the softening agent is excessively small, the small molecular weight may cause, for example, the transfer of a substance from the pressure-sensitive adhesive layer (the above-mentioned first pressure-sensitive adhesive layer and the above-mentioned second pressure-sensitive adhesive layer) to the adherend or heavy release. On the other hand, when the molecular weight of the softening agent is excessively large, an improving effect on the adhesive strength tends to be poor. Accordingly, the number-average molecular weight of the softening agent is preferably 5000 to 100,000, or more preferably 10,000 to 50,000.

When the softening agent is used, any appropriate amount can be adopted as its addition amount. When the addition amount of the softening agent is excessively large, the amount of an adhesive residue at the time of exposure to high temperatures or outdoors tends to increase. Accordingly, the addition amount is preferably 40 parts by weight or less, more preferably 20 parts by weight or less, or still more preferably 10 parts by weight or less with respect to 100 parts by weight of the pressure-sensitive adhesive. When the addition amount of the softening agent exceeds 40 parts by weight with respect to 100 parts by weight of the pressure-sensitive adhesive, the adhesive residue under a high-temperature environment or under exposure to outdoors becomes remarkable.

Examples of the above-mentioned UV absorbing agent include a benzotriazole-based compound, a benzophenone-based compound, and a benzoate-based compound. Any appropriate content can be adopted as the content of the above-mentioned UV absorbing agent as long as the agent does not bleed out at the time of the forming. The content is representatively 0.01 part by weight to 5 parts by weight with respect to 100 parts by weight of the pressure-sensitive adhesive.

Examples of the above-mentioned thermal stabilizer include a hindered amine-based compound, a phosphorus-based compound, and a cyanoacrylate-based compound. Any appropriate content can be adopted as the content of the above-mentioned thermal stabilizer as long as the stabilizer does not bleed out at the time of the forming. The content is representatively 0.01 part by weight to 5 parts by weight with respect to 100 parts by weight of the pressure-sensitive adhesive.

One, or each of both, of the surfaces of each of the above-mentioned first pressure-sensitive adhesive layer and the above-mentioned second pressure-sensitive adhesive layer may be subjected to a surface treatment as required. Examples of the surface treatment include a corona discharge treatment, a UV irradiation treatment, a flame treatment, a plasma treatment, and a sputter etching treatment.

The above-mentioned first pressure-sensitive adhesive layer has a storage modulus (G′) of preferably 1.0×10⁶ Pa or more and less than 1.0×10⁹ Pa, more preferably 1.0×10⁶ Pa or more and less than 1.0×10⁶ Pa, or still more preferably 1.0×10⁶ Pa or more and less than 1.0×10⁷ Pa at a frequency of 10 Hz and 23° C. As long as the storage modulus of the above-mentioned first pressure-sensitive adhesive layer falls within the above-mentioned range, when a member having unevenness on its surface is protected with the pressure-sensitive adhesive tape of the present invention having the first pressure-sensitive adhesive layer and the resultant is deformed by, for example, lamination or continuous winding, the deformation of the uneven shape and damage to the base material layer in the pressure-sensitive adhesive tape can be effectively prevented. In addition, for example, when a prism sheet is protected with the pressure-sensitive adhesive tape of the present invention and the resultant is brought into a state such as a laminated state or a continuously wound state, the emergence of irregularity (indentation) in the external appearance of the prism sheet to which the pressure-sensitive adhesive tape is attached can be effectively suppressed.

The above-mentioned second pressure-sensitive adhesive layer has a storage modulus (G′) of preferably 1.0×10³ Pa or more and less than 1.0×10⁶ Pa, more preferably 5.0×10³ Pa or more and less than 1.0×10⁶ Pa, or still more preferably 1.0×10⁴ Pa or more and less than 1.0×10⁶ Pa at a frequency of 10 Hz and 23° C. As long as the storage modulus of the above-mentioned second pressure-sensitive adhesive layer falls within the above-mentioned range, the pressure-sensitive adhesive tape of the present invention having the second pressure-sensitive adhesive layer can bring together sufficient pressure-sensitive adhesiveness for, and sufficient releasability from, a member having unevenness on its surface. In addition, the pressure-sensitive adhesive tape of the present invention can bring together, for example, sufficient pressure-sensitive adhesiveness for, and sufficient releasability from, a prism sheet.

It should be noted that the term “storage modulus (G′)” as used in the present invention refers to a value measured with a dynamic viscoelasticity spectrum-measuring device (ARES manufactured by Rheometric Scientific) at a frequency of 10 Hz and a rate of temperature increase of 5° C./min in the range of −50° C. to 100° C. In addition, in the case of a laminate in which two or more pressure-sensitive adhesive layers are laminated like the pressure-sensitive adhesive tape of the present invention, it is sufficient that: the laminate be obliquely cut with, for example, a surface and interfacial cutting analysis system (SAICAS); and multiple sites of the cut surface be subjected to measurement with a microhardness-measuring apparatus such as a nanoindenter.

In the pressure-sensitive adhesive tape of the present invention, the storage modulus of the above-mentioned first pressure-sensitive adhesive layer is preferably higher than the storage modulus of the above-mentioned second pressure-sensitive adhesive layer. As long as the storage modulus of the above-mentioned first pressure-sensitive adhesive layer is higher than the storage modulus of the above-mentioned second pressure-sensitive adhesive layer, the pressure-sensitive adhesive tape of the present invention can bring together sufficient pressure-sensitive adhesiveness for, and sufficient releasability from, a member having unevenness on its surface. Further, even upon deformation of the member protected with the pressure-sensitive adhesive tape by, for example, lamination or continuous winding, the uneven shape hardly deforms and the base material layer in the pressure-sensitive adhesive tape is hardly damaged. In addition, the pressure-sensitive adhesive tape of the present invention can bring together, for example, sufficient pressure-sensitive adhesiveness for, and sufficient releasability from, a prism sheet. Further, when a prism sheet protected with the pressure-sensitive adhesive tape is brought into a state such as a laminated state or a continuously wound state, the emergence of irregularity (indentation) in the external appearance of the prism sheet to which the pressure-sensitive adhesive tape is attached can be effectively suppressed. In the pressure-sensitive adhesive tape of the present invention, a difference between the storage modulus of the above-mentioned first pressure-sensitive adhesive layer at a frequency of 10 Hz and 23° C., and the storage modulus of the above-mentioned second pressure-sensitive adhesive layer at a frequency of 10 Hz and 23° C. is preferably 3×10⁵ Pa or more. The above-mentioned difference in storage modulus is more preferably 4×10⁵ Pa to 1×10⁷ Pa, or still more preferably 5×10⁵ Pa to 5×10⁶ Pa. As long as the difference between the storage modulus of the above-mentioned first pressure-sensitive adhesive layer at a frequency of 10 Hz and 23° C., and the storage modulus of the above-mentioned second pressure-sensitive adhesive layer at a frequency of 10 Hz and 23° C. is 3×10⁵ Pa or more, the pressure-sensitive adhesive tape of the present invention can bring together sufficient pressure-sensitive adhesiveness for, and sufficient releasability from, a member having unevenness on its surface. Further, even upon deformation of the member protected with the pressure-sensitive adhesive tape by, for example, lamination or continuous winding, the uneven shape hardly deforms and the base material layer in the pressure-sensitive adhesive tape is hardly damaged. In addition, the pressure-sensitive adhesive tape can bring together, for example, sufficient pressure-sensitive adhesiveness for, and sufficient releasability from, a prism sheet. Further, when a prism sheet protected with the pressure-sensitive adhesive tape is brought into a state such as a laminated state or a continuously wound state, the emergence of irregularity (indentation) in the external appearance of the prism sheet to which the pressure-sensitive adhesive tape is attached can be effectively suppressed.

### A-3. Releasing Layer

The releasing layer used in the pressure-sensitive adhesive tape of the present invention may contain a releasing agent such as a silicone-based releasing agent, a fluorine-based releasing agent, a long-chain alkyl-based releasing agent, or an aliphatic amide-based releasing agent as required. When the releasing layer contains the releasing agent, attachment between the releasing layer and the second pressure-sensitive adhesive layer in a state where portions of the pressure-sensitive adhesive tape overlap each other such as storage in a roll shape can be prevented. In addition, there is no need to cover the releasing layer with a separator layer, and hence a pressure-sensitive adhesive tape having a desired haze value and desired surface roughness can be easily obtained. Of the above-mentioned releasing agents, the long-chain alkyl-based releasing agent is particularly preferred. In addition, a method of subjecting the releasing layer to a releasing treatment is not limited to an approach involving adding any one of various releasing materials such as the above-mentioned releasing agents. Any appropriate approach involving subjecting the releasing layer to a friction treatment or involving irradiating the releasing layer with electron beams to cause the layer to express releasability may be employed to such an extent that an effect of the present invention is not impaired.

The above-mentioned long-chain alkyl-based releasing agent contains a long-chain alkyl-based polymer. The long-chain alkyl-based polymer can be obtained by causing a polymer having a reactive group and a compound having an alkyl group capable of reacting with the reactive group to react with each other in any appropriate heated solvent. A catalyst may be used as required at the time of the reaction. Examples of the catalyst include a tin compound and a tertiary amine.

Examples of the above-mentioned reactive group include a hydroxyl group, an amino group, a carboxyl group, and a maleic anhydride group. Examples of a polymer having the reactive group include an ethylene-vinyl alcohol copolymer, polyvinyl alcohol, polyethylenimine, polyethylenamine, a styrene-maleic anhydride copolymer. Of those, an ethylene-vinyl alcohol copolymer is preferred. It should be noted that the term “ethylene-vinyl alcohol copolymer” also includes a partially saponified product of ethylene-vinyl acetate copolymer. The term “polyvinyl alcohol” also includes a partially saponified product of polyvinyl acetate.

The number of carbon atoms of the above-mentioned alkyl group is preferably 8 to 30, or more preferably 12 to 22. When the number of carbon atoms of the above-mentioned alkyl group falls within such range, a surface layer having excellent releasability can be obtained. Specific examples of such alkyl group include a lauryl group, a stearyl group, and a behenyl group. Examples of a compound having such alkyl group (that is, compound having an alkyl group capable of reacting with the above-mentioned reactive group) include: isocyanates such as octyl isocyanate, decyl isocyanate, lauryl isocyanate, and stearyl isocyanate; acid chlorides; amines; and alcohols. Of those, isocyanates are preferred.

The above-mentioned long-chain alkyl-based polymer has a weight-average molecular weight of preferably 10,000 to 1,000,000, or more preferably 20,000 to 1,000,000. When the weight-average molecular weight of the long-chain alkyl-based polymer falls within such range, a releasing layer having excellent releasability can be obtained.

The above-mentioned long-chain alkyl-based releasing agent is kneaded into the releasing layer upon co-extrusion of the pressure-sensitive adhesive tape. The content of the long-chain alkyl-based releasing agent in the above-mentioned releasing layer is preferably 1% by weight to 50% by weight, more preferably 2% by weight to 30% by weight, or particularly preferably 5% by weight to 20% by weight. When the content is smaller than 1% by weight, an effect of adding the long-chain alkyl-based releasing agent may not be obtained. When the content is larger than 50% by weight, a bled product may be generated.

When the releasing layer is formed by application, any appropriate releasing treatment agent can be adopted as a releasing treatment agent for a light-releasing treatment to be used. Examples of the releasing treatment agent include long-chain alkyl-based, fluorine-containing long-chain alkyl-based, and silicone-based releasing treatment agents. The silicone-based releasing agents are classified into, for example, an addition reaction thermosetting type, a condensation reaction thermosetting type, and a type curable with radiation such as UV light or electron beams.

### B. Method of Producing Pressure-Sensitive Adhesive Tape

The pressure-sensitive adhesive tape of the present invention can be obtained by any appropriate production method. Examples of the production method for the pressure-sensitive adhesive tape of the present invention include: a method involving subjecting the above-mentioned base material layer, the above-mentioned first pressure-sensitive adhesive layer, and the above-mentioned second pressure-sensitive adhesive layer of which the pressure-sensitive adhesive tape of the present invention is constituted to co-extrusion (production method 1); a method involving performing the hot-melt application of the above-mentioned first pressure-sensitive adhesive layer and the above-mentioned second pressure-sensitive adhesive layer in the stated order onto the above-mentioned base material layer (production method 2); and a method involving applying an organic solvent application liquid in which the above-mentioned first pressure-sensitive adhesive layer is dissolved or an emulsion liquid in which the above-mentioned first pressure-sensitive adhesive layer is water-dispersed onto the above-mentioned base material layer and applying an organic solvent application liquid in which the above-mentioned second pressure-sensitive adhesive layer is dissolved or an emulsion liquid in which the above-mentioned second pressure-sensitive adhesive layer is water-dispersed onto the applied liquid (production method 3).

When the pressure-sensitive adhesive tape is produced by the above-mentioned production method 1 or 2, the above-mentioned thermoplastic pressure-sensitive adhesive is preferably used as the pressure-sensitive adhesive of which the pressure-sensitive adhesive layer (first pressure-sensitive adhesive layer or second pressure-sensitive adhesive layer) is constituted.

A method for the above-mentioned co-extrusion in the above-mentioned production method 1 can be performed with an extruder and a co-extrusion die for the respective materials of which the base material layer, the first pressure-sensitive adhesive layer, and the above-mentioned second pressure-sensitive adhesive layer are formed in conformity with, for example, an inflation method or a T-die method.

When the pressure-sensitive adhesive tape is produced by the above-mentioned production method 2 or 3, the surface onto which the pressure-sensitive adhesive layer (first pressure-sensitive adhesive layer and second pressure-sensitive adhesive layer) is formed, that is, the above-mentioned base material layer is subjected to an easy-adhesion treatment. Examples of the easy-adhesion treatment include a corona discharge treatment, an ITRO treatment (silicification flame treatment), and an anchor coat treatment.

When the pressure-sensitive adhesive tape is produced by the above-mentioned production method 3, the above-mentioned rubber-based pressure-sensitive adhesive, acrylic pressure-sensitive adhesive, or silicone-based pressure-sensitive adhesive is preferably used as a pressure-sensitive adhesive of which the above-mentioned pressure-sensitive adhesive layer (first pressure-sensitive adhesive layer and second pressure-sensitive adhesive layer) is constituted.

When the pressure-sensitive adhesive tape is produced by the above-mentioned production method 3, any appropriate solvent can be adopted as the above-mentioned organic solvent. Examples of the above-mentioned organic solvent include: aromatic hydrocarbon-based solvents such as toluene and xylene; aliphatic carboxylic acid ester-based solvents such as ethyl acetate; and aliphatic hydrocarbon-based solvents such as hexane, heptane, and octane. One kind of the above-mentioned organic solvents may be used alone, or two or more kinds of them may be used in combination.

When the pressure-sensitive adhesive tape is produced by the above-mentioned production method 3, a cross-linking agent may be incorporated into the organic solvent application liquid. Examples of the cross-linking agent include an epoxy-based cross-linking agent, an isocyanate-based cross-linking agent, and an aziridine cross-linking agent.

Any appropriate application method can be adopted as an application method when the pressure-sensitive adhesive tape is produced by the above-mentioned production method 3. Examples of the application method include methods each involving the use of a bar coater, a gravure coater, a spin coater, a roll coater, a knife coater, or an applicator.

### EXAMPLES

Hereinafter, the present invention is specifically described by way of examples. However, the present invention is by no means limited by these examples. It should be noted that, in the examples and the like, test and evaluation methods are as described below, and the term “part(s)” means “part(s) by weight.”

### (1) Storage Modulus (G′)

A material of which each pressure-sensitive adhesive layer was formed was kneaded with a biaxial kneader, and was then formed into a film shape (200 μm). The storage modulus of the formed sample was measured with a dynamic viscoelasticity spectrum-measuring device (ARES manufactured by Rheometric Scientific) at a frequency of 10 Hz and a rate of temperature increase of 5° C./min in the range of −50° C. to 100° C.

### (2) Evaluation for Adhesion

The adhesion of a pressure-sensitive adhesive tape was measured in conformity with JIS Z0237 (2000). A test sample obtained by cutting the pressure-sensitive adhesive tape so as to have a predetermined width (20 mm) was attached to a prism sheet (pitch=50 μm, apex angle=90°, composition: acrylic resin), and then the resultant was subjected to crimping with a rubber roller at a load of 2 kg once. After that, the resultant was left to stand at a load of 11 g/cm² under a 50° C. atmosphere for 24 hours. The sample was peeled in a 180° direction at a tension speed of 300 ram/min, and a resistance at the time was defined as the adhesion of the test sample. The whole peeling operation was performed under an atmosphere having a temperature of 23° C. and a humidity of 65% RH (relative humidity).

### (3) Evaluation for Prism Sheet Lens Apex Angle Portion Indentation Depth

A test sample obtained by cutting a pressure-sensitive adhesive tape into a size measuring 20 cm by 5 cm was attached to a prism sheet cut into a size measuring 20 cm by 5 cm, and then the resultant was subjected to crimping with a rubber roller at a load of 2 kg once. After that, the resultant was left to stand at a load of 11 g/cm² under a 50° C. atmosphere for 24 hours. After that, the test sample was peeled from the prism sheet, and then the surface of the test sample attached to the prism sheet was evaluated for prism sheet lens apex angle portion indentation depth with an optical profiler (Wyko NT9100 manufactured by Veeco Instruments). The measurement was performed under the following conditions “Measurement Type: VSI, Objective Lens: ×2.5, Internal Lens: ×0.5, Backscan: 10 μm, Length: 15 μm, threshold: 1%, Window Filtering: None, 5 mm×5 mm, n=10.” The average of the data was calculated.

### (4) Evaluation for Deformation of Prism Sheet Apex Angle

The uneven surface of the prism sheet from which the test sample had been peeled in the above-mentioned section (3) was visually observed and evaluated for whether or not an apex angle deformed. The evaluation can be performed because, when the apex angle deformed, only the deformed portion shows a color different from that of any other portion owing to the refraction of light.

o: No deformation was observed.

x: Deformation was observed.

### (5) Observation of Indentation

A lens surface of the prism sheet from which the test sample had been peeled in the above-mentioned section (3) was visually observed, and then observation as to whether or not an indentation emerged was performed.

o: No indentation was observed.

x: An indentation was observed.

### Example 1

The following compounds were prepared as a base material layer-forming material, a first pressure-sensitive adhesive layer-forming material, and a second pressure-sensitive adhesive layer-forming material.

Base Material Layer-Forming Material: a Block Polypropylene (PF380A Manufactured by SunAllomer Ltd.)

First pressure-sensitive adhesive layer-forming material: A mixture of 70 parts of a styrene-based elastomer formed of a hydrogenated product of a styrene-butadiene-based copolymer (Tuftec H1041 manufactured by Asahi Kasei Chemicals Corporation) and 30 parts of a tackifier (ARCON P-125 manufactured by Arakawa Chemical Industries, Ltd.)

Second pressure-sensitive adhesive layer-forming material: A mixture of 70 parts of a styrene-based elastomer formed of a hydrogenated product of a styrene-butadiene-based copolymer (DYNARON 1320P manufactured by JSR Corporation) and 30 parts of a tackifier (ARCON P-125 manufactured by Arakawa Chemical Industries, Ltd.)

The above-mentioned materials were molded by three kind-three layer inflation co-extrusion. Thus, a pressure-sensitive adhesive tape (1) including the base material layer, the first pressure-sensitive adhesive layer, and the second pressure-sensitive adhesive layer in the stated order was obtained. The base material layer had a thickness of 38 μm, the first pressure-sensitive adhesive layer had a thickness of 4 μm, and the second pressure-sensitive adhesive layer had a thickness of 4 μm. Table 1 shows the results of the evaluation of the resultant pressure-sensitive adhesive tape (1).

### Example 2

A pressure-sensitive adhesive tape (2) was obtained in the same manner as in Example 1 except that: a mixture of 70 parts of a styrene-based elastomer formed of a hydrogenated product of a styrene-butadiene-based copolymer (Tuftec H1041 manufactured by Asahi Kasei Chemicals Corporation) and 30 parts of a tackifier (ARCON P-125 manufactured by Arakawa Chemical Industries, Ltd.) was used as the first pressure-sensitive adhesive layer-forming material; and a mixture of 70 parts of a styrene-based elastomer formed of a hydrogenated product of a styrene-butadiene-based copolymer (Tuftec H1221 manufactured by Asahi Kasei Chemicals Corporation) and 30 parts of a tackifier (ARCON P-125 manufactured by Arakawa Chemical Industries, Ltd.) was used as the second pressure-sensitive adhesive layer-forming material. The base material layer had a thickness of 38 μm, the first pressure-sensitive adhesive layer had a thickness of 4 μm, and the second pressure-sensitive adhesive layer had a thickness of 4 μm. Table 1 shows the results of the evaluation of the resultant pressure-sensitive adhesive tape (2).

### Example 3

A pressure-sensitive adhesive tape (3) was obtained in the same manner as in Example 1 except that: a mixture of 70 parts of a styrene-based elastomer formed of a hydrogenated product of a styrene-butadiene-based copolymer (Tuftec H1041 manufactured by Asahi Kasei Chemicals Corporation) and 30 parts of a tackifier (ARGON P-125 manufactured by Arakawa Chemical Industries, Ltd.) was used as the first pressure-sensitive adhesive layer-forming material; and a mixture of 70 parts of a styrene-based elastomer formed of a hydrogenated product of a styrene-butadiene-based copolymer (G1657 manufactured by Kraton Polymers) and 30 parts of a tackifier (ARCON P-125 manufactured by Arakawa Chemical Industries, Ltd.) was used as the second pressure-sensitive adhesive layer-forming material. The base material layer had a thickness of 38 μm, the first pressure-sensitive adhesive layer had a thickness of 4 μm, and the second pressure-sensitive adhesive layer had a thickness of 4 μm. Table 1 shows the results of the evaluation of the resultant pressure-sensitive adhesive tape (3).

### Example 4

A pressure-sensitive adhesive tape (4) was obtained in the same manner as in Example 1 except that: a mixture of 75 parts of a styrene-based elastomer formed of a hydrogenated product of a styrene-butadiene-based copolymer (Tuftec H1041 manufactured by Asahi Kasei Chemicals Corporation) and 25 parts of a tackifier (ARCON P-125 manufactured by Arakawa Chemical Industries, Ltd.) was used as the first pressure-sensitive adhesive layer-forming material; and a mixture of 75 parts of a styrene-based elastomer formed of a hydrogenated product of a styrene-butadiene-based copolymer (DYNARON 1320P manufactured by JSR Corporation) and 25 parts of a tackifier (ARCON P-125 manufactured by Arakawa Chemical Industries, Ltd.) was used as the second pressure-sensitive adhesive layer-forming material. The base material layer had a thickness of 38 μm, the first pressure-sensitive adhesive layer had a thickness of 4 μm, and the second pressure-sensitive adhesive layer had a thickness of 4 μm. Table 1 shows the results of the evaluation of the resultant pressure-sensitive adhesive tape (4).

### Example 5

A pressure-sensitive adhesive tape (5) was obtained in the same manner as in Example 1 except that: a mixture of 75 parts of a styrene-based elastomer formed of a hydrogenated product of a styrene-butadiene-based copolymer (Tuftec H1041 manufactured by Asahi Kasei Chemicals Corporation) and 25 parts of a tackifier (ARCON P-125 manufactured by Arakawa Chemical Industries, Ltd.) was used as the first pressure-sensitive adhesive layer-forming material; and a mixture of 75 parts of a styrene-based elastomer formed of a hydrogenated product of a styrene-butadiene-based copolymer (G1657 manufactured by Kraton Polymers) and 25 parts of a tackifier (ARCON P-125 manufactured by Arakawa Chemical Industries, Ltd.) was used as the second pressure-sensitive adhesive layer-forming material. The base material layer had a thickness of 38 μm, the first pressure-sensitive adhesive layer had a thickness of 4 μm, and the second pressure-sensitive adhesive layer had a thickness of 4 μm. Table 1 shows the results of the evaluation of the resultant pressure-sensitive adhesive tape (5).

### Example 6

A pressure-sensitive adhesive tape (6) was obtained in the same manner as in Example 1 except that: a mixture of 85 parts of a styrene-based elastomer formed of a hydrogenated product of a styrene-butadiene-based copolymer (Tuftec H1041 manufactured by Asahi Kasei Chemicals Corporation) and 15 parts of a tackifier (ARCON P-125 manufactured by Arakawa Chemical Industries, Ltd.) was used as the first pressure-sensitive adhesive layer-forming material; and a mixture of 85 parts of a styrene-based elastomer formed of a hydrogenated product of a styrene-butadiene-based copolymer (DYNARON 1320P manufactured by JSR Corporation) and 15 parts of a tackifier (ARCON P-125 manufactured by Arakawa Chemical Industries, Ltd.) was used as the second pressure-sensitive adhesive layer-forming material. The base material layer had a thickness of 38 μm, the first pressure-sensitive adhesive layer had a thickness of 4 μm, and the second pressure-sensitive adhesive layer had a thickness of 4 μm. Table 1 shows the results of the evaluation of the resultant pressure-sensitive adhesive tape (6).

### Example 7

A pressure-sensitive adhesive tape (7) was obtained in the same manner as in Example 1 except that: a mixture of 95 parts of a styrene-based elastomer formed of a hydrogenated product of a styrene-butadiene-based copolymer (Tuftec H1041 manufactured by Asahi Kasei Chemicals Corporation) and 5 parts of a tackifier (ARCON P-125 manufactured by Arakawa Chemical Industries, Ltd.) was used as the first pressure-sensitive adhesive layer-forming material; and a mixture of 95 parts of a styrene-based elastomer formed of a hydrogenated product of a styrene-butadiene-based copolymer (DYNARON 1320P manufactured by JSR Corporation) and 5 parts of a tackifier (ARCON P-125 manufactured by Arakawa Chemical Industries, Ltd.) was used as the second pressure-sensitive adhesive layer-forming material. The base material layer had a thickness of 38 μm, the first pressure-sensitive adhesive layer had a thickness of 4 μm, and the second pressure-sensitive adhesive layer had a thickness of 4 μm. Table 1 shows the results of the evaluation of the resultant pressure-sensitive adhesive tape (7).

### Example 8

A pressure-sensitive adhesive tape (8) was obtained in the same manner as in Example 1 except that: a mixture of 95 parts of a styrene-based elastomer formed of a hydrogenated product of a styrene-butadiene-based copolymer (Tuftec H1062 manufactured by Asahi Kasei Chemicals Corporation) and 5 parts of a tackifier (ARCON P-125 manufactured by Arakawa Chemical Industries, Ltd.) was used as the first pressure-sensitive adhesive layer-forming material; and a mixture of 95 parts of a styrene-based elastomer formed of a hydrogenated product of a styrene-butadiene-based copolymer (DYNARON 1320P manufactured by JSR Corporation) and 5 parts of a tackifier (ARCON P-125 manufactured by Arakawa Chemical Industries, Ltd.) was used as the second pressure-sensitive adhesive layer-forming material. The base material layer had a thickness of 38 μm, the first pressure-sensitive adhesive layer had a thickness of 4 μm, and the second pressure-sensitive adhesive layer had a thickness of 4 μm. Table 1 shows the results of the evaluation of the resultant pressure-sensitive adhesive tape (8).

### Comparative Example 1

A pressure-sensitive adhesive tape (C1) was obtained in the same manner as in Example 1 except that: 100 parts of a styrene-based elastomer formed of a hydrogenated product of a styrene-butadiene-based copolymer (Tuftec H1041 manufactured by Asahi Kasei Chemicals Corporation) were used as the first pressure-sensitive adhesive layer-forming material; and the second pressure-sensitive adhesive layer-forming material was not used. The base material layer had a thickness of 38 μm and the pressure-sensitive adhesive layer had a thickness of 8 μm. Table shows the results of the evaluation of the resultant pressure-sensitive adhesive tape (C1).

### Comparative Example 2

A pressure-sensitive adhesive tape (C2) was obtained in the same manner as in Example 1 except that: the first pressure-sensitive adhesive layer-forming material was not used; and a mixture of 70 parts of a styrene-based elastomer formed of a hydrogenated product of a styrene-butadiene-based copolymer (DYNARON 1320P manufactured by JSR Corporation) and 30 parts of a tackifier (ARCON P-125 manufactured by Arakawa Chemical Industries, Ltd.) was used as the second pressure-sensitive adhesive layer-forming material. The base material layer had a thickness of 38 μm and the pressure-sensitive adhesive layer had a thickness of 8 μm. Table 2 shows the results of the evaluation of the resultant pressure-sensitive adhesive tape (C2).

### Comparative Example 3

A pressure-sensitive adhesive tape (C3) was obtained in the same manner as in Example 1 except that: 100 parts of a styrene-based elastomer formed of a hydrogenated product of a styrene-butadiene-based copolymer (Tuftec H1041 manufactured by Asahi Kasei Chemicals Corporation) were used as the first pressure-sensitive adhesive layer-forming material; and 100 parts of a styrene-based elastomer formed of a hydrogenated product of a styrene-butadiene-based copolymer (Tuftec H1062 manufactured by Asahi Kasei Chemicals Corporation) were used as the second pressure-sensitive adhesive layer-forming material. The base material layer had a thickness of 38 μm, the first pressure-sensitive adhesive layer had a thickness of 4 μm, and the second pressure-sensitive adhesive layer had a thickness of 4 μm. Table shows the results of the evaluation of the resultant pressure-sensitive adhesive tape (C3).

### Comparative Example 4

A pressure-sensitive adhesive tape (C4) was obtained in the same manner as in Example 1 except that: a mixture of 95 parts of a styrene-based elastomer formed of a hydrogenated product of a styrene-butadiene-based copolymer (Tuftec H1041 manufactured by Asahi Kasei Chemicals Corporation) and 5 parts of a tackifier (ARCON P-125 manufactured by Arakawa Chemical Industries, Ltd.) was used as the first pressure-sensitive adhesive layer-forming material; and a mixture of 95 parts of a styrene-based elastomer formed of a hydrogenated product of a styrene-butadiene-based copolymer (Tuftec H1062 manufactured by Asahi Kasei Chemicals Corporation) and 5 parts of a tackifier (ARCON P-125 manufactured by Arakawa Chemical Industries, Ltd.) was used as the second pressure-sensitive adhesive layer-forming material. The base material layer had a thickness of 38 μm, the first pressure-sensitive adhesive layer had a thickness of 4 μm, and the second pressure-sensitive adhesive layer had a thickness of 4 μm. Table 3 shows the results of the evaluation of the resultant pressure-sensitive adhesive tape (C4).

### Comparative Example 5

A pressure-sensitive adhesive tape (C5) was obtained in the same manner as in Example 1 except that: a mixture of 85 parts of a styrene-based elastomer formed of a hydrogenated product of a styrene-butadiene-based copolymer (DYNARON 1320P manufactured by JSR Corporation) and 15 parts of a tackifier (ARCONP-125 manufactured by Arakawa Chemical Industries, Ltd.) was used as the first pressure-sensitive adhesive layer-forming material; and a mixture of 85 parts of a styrene-based elastomer formed of a hydrogenated product of a styrene-butadiene-based copolymer (Tuftec H1041 manufactured by Asahi Kasei Chemicals Corporation) and 15 parts of a tackifier (ARCON P-125 manufactured by Arakawa Chemical Industries, Ltd.) was used as the second pressure-sensitive adhesive layer-forming material. The base material layer had a thickness of 38 μm, the first pressure-sensitive adhesive layer had a thickness of 4 μm, and the second pressure-sensitive adhesive layer had a thickness of 4 μm. Table 3 shows the results of the evaluation of the resultant pressure-sensitive adhesive tape (C5).

### Comparative Example 6

A pressure-sensitive adhesive tape (C6) was obtained in the same manner as in Example 1 except that: a mixture of 95 parts of a styrene-based elastomer formed of a hydrogenated product of a styrene-butadiene-based copolymer (Tuftec H1221 manufactured by Asahi Kasei Chemicals Corporation) and 5 parts of a tackifier (ARCON P-125 manufactured by Arakawa Chemical Industries, Ltd.) was used as the first pressure-sensitive adhesive layer-forming material; and a mixture of 95 parts of a styrene-based elastomer formed of a hydrogenated product of a styrene-butadiene-based copolymer (Tuftec H1062 manufactured by Asahi Kasei Chemicals Corporation) and 5 parts of a tackifier (ARCON P-125 manufactured by Arakawa Chemical Industries, Ltd.) was used as the second pressure-sensitive adhesive layer-forming material. The base material layer had a thickness of 38 μm, the first pressure-sensitive adhesive layer had a thickness of 4 μm, and the second pressure-sensitive adhesive layer had a thickness of 4 μm. Table 3 shows the results of the evaluation of the resultant pressure-sensitive adhesive tape (C6).

### Comparative Example 7

A pressure-sensitive adhesive tape (C7) was obtained in the same manner as in Example 1 except that: a mixture of 70 parts of a styrene-based elastomer formed of a hydrogenated product of a styrene-butadiene-based copolymer (G1657 manufactured by Kraton Polymers) and 30 parts of a tackifier (ARCON P-125 manufactured by Arakawa Chemical Industries, Ltd.) was used as the first pressure-sensitive adhesive layer-forming material; and a mixture of 70 parts of a styrene-based elastomer formed of a hydrogenated product of a styrene-butadiene-based copolymer (DYNARON 1320P manufactured by JSR Corporation) and 30 parts of a tackifier (ARCON P-125 manufactured by Arakawa Chemical Industries, Ltd.) was used as the second pressure-sensitive adhesive layer-forming material. The base material layer had a thickness of 38 μm, the first pressure-sensitive adhesive layer had a thickness of 4 μm, and the second pressure-sensitive adhesive layer had a thickness of 4 μm. Table 3 shows the results of the evaluation of the resultant pressure-sensitive adhesive tape (C7).

### Comparative Example 8

A pressure-sensitive adhesive tape (C8) was obtained in the same manner as in Example 1 except that: a mixture of 75 parts of a styrene-based elastomer formed of a hydrogenated product of a styrene-butadiene-based copolymer (G1657 manufactured by Kraton Polymers) and 25 parts of a tackifier (ARCON P-125 manufactured by Arakawa Chemical Industries, Ltd.) was used as the first pressure-sensitive adhesive layer-forming material; and a mixture of 75 parts of a styrene-based elastomer formed of a hydrogenated product of a styrene-butadiene-based copolymer (DYNARON 1320P manufactured by JSR Corporation) and 25 parts of a tackifier (ARCON P-125 manufactured by Arakawa Chemical Industries, Ltd.) was used as the second pressure-sensitive adhesive layer-forming material. The base material layer had a thickness of 38 μm, the first pressure-sensitive adhesive layer had a thickness of 4 μm, and the second pressure-sensitive adhesive layer had a thickness of 4 μm. Table 3 shows the results of the evaluation of the resultant pressure-sensitive adhesive tape (C8).

TABLE 1

| | | | Example | Example | Example | Example | Example | Example | Example | Example |
|---|---|---|---|---|---|---|---|---|---|---|
| Base material | Trade name of | | 1 | 2 | 3 | 4 | 5 | 6 | 7 | 8 |
| layer | material | | PF380A | | | | | | | |
| First pressure- | Trade | Rubber- | Tuftec | Tuftec | Tuftec | Tuftec | Tuftec | Tuftec | Tuftec | Tuftec |
| sensitive | name | based resin | H1041 | H1041 | H1041 | H1041 | H1041 | H1041 | H1041 | H1062 |
| adhesive layer | | component | | | | | | | | |
| | | Tackifier | ARCON | ARCON | ARCON | ARCON | ARCON | ARCON | ARCON | ARCON |
| | | | P125 | P125 | P125 | P125 | P125 | P125 | P125 | P125 |
| | Rubber-based resin | | 70/30 | 70/30 | 70/30 | 75/25 | 75/25 | 85/15 | 95/5 | 95/5 |
| | component/Tackifier | | | | | | | | | |
| | Storage modulus | | 1.3 × 10⁶ | 1.3 × 10⁶ | 1.3 × 10⁶ | 1.3 × 10⁶ | 1.3 × 10⁶ | 1.6 × 10⁶ | 2.0 × 10⁶ | 4.5 × 10⁶ |
| | (Pa) | | | | | | | | | |
| Second pressure- | Trade | Rubber- | DYNARON | Tuftec | G1657 | DYNARON | G1657 | DYNARON | DYNARON | DYNARON |
| sensitive | name | based resin | 1320P | H1221 | | 1320P | | 1320P | 1320P | 1320P |
| adhesive layer | | component | | | | | | | | |
| | | Tackifier | ARCON | ARCON | ARCON | ARCON | ARCON | ARCON | ARCON | ARCON |
| | | | P125 | P125 | P125 | P125 | P125 | P125 | P125 | P125 |

| | | | | | | | | |
|---|---|---|---|---|---|---|---|---|
| Rubber-based resin | 70/30 | 70/30 | 70/30 | 75/25 | 75/25 | 85/15 | 95/5 | 95/5 |
| component/Tackifier | | | | | | | | |
| Storage modulus | 4.1 × 10⁵ | 7.0 × 10⁵ | 6.7 × 10⁵ | 4.2 × 10⁵ | 5.2 × 10⁵ | 4.4 × 10⁵ | 5.9 × 10⁵ | 5.9 × 10⁵ |
| (Pa) | | | | | | | | |

| | | | | | | | | |
|---|---|---|---|---|---|---|---|---|
| Adhesion (N/20 mm) | 0.04 | 0.03 | 0.03 | 0.075 | 0.03 | 0.04 | 0.045 | 0.045 |
| Prism sheet lens apex angle portion | 5.89 | 3.7 | 5.89 | 5.2 | 4.28 | 4.07 | 3.37 | 3.37 |
| indentation depth (μm) | | | | | | | | |
| Deformation of prism sheet lens | ∘ | ∘ | ∘ | ∘ | ∘ | ∘ | ∘ | ∘ |
| apex angle | | | | | | | | |
| Indentation | ∘ | ∘ | ∘ | ∘ | ∘ | ∘ | ∘ | ∘ |

TABLE 2

| | | | Comparative | Comparative |
|---|---|---|---|---|
| | | | Example 1 | Example 2 |
| Base material layer | Trade name of material | | PF380A | |
| First | Trade | Rubber-based resin component | Tuftec | DYNARON |
| pressure-sensitive | name | | H1041 | 1320P |
| adhesive layer | | Tackifier | — | ARCON P125 |

| | | |
|---|---|---|
| Rubber-based resin component/Tackifier | 100/0 | 70/30 |
| Storage modulus (Pa) | 3.2 × 10⁶ | 4.1 × 10⁵ |

| | | |
|---|---|---|
| Adhesion | Not bonded | 0.08 |
| (N/20 mm) | | |
| Prism sheet lens apex angle portion indentation depth | 0 | 11.2 |
| (μm) | | |
| Deformation of prism sheet lens apex angle | ∘ | x |
| Indentation | ∘ | x |

TABLE 3

| | | | Comparative | Comparative | Comparative | Comparative | Comparative | Comparative |
|---|---|---|---|---|---|---|---|---|
| | | | Example 3 | Example 4 | Example 5 | Example 6 | Example 7 | Example 8 |
| Base material layer | Trade name of material | | PF380A | | | | | |
| First pressure- | Trade | Rubber-based | Tuftec | Tuftec | DYNARON | Tuftec | G1657 | G1657 |
| sensitive adhesive | name | resin component | H1041 | H1041 | 1320P | H1221 | | |
| layer | | Tackifier | — | ARCON P125 | ARCON P125 | ARCON P125 | ARCON P125 | ARCON P125 |
| | Rubber-based resin | | 100/0 | 95/5 | 85/15 | 95/5 | 70/30 | 75/25 |
| | component/Tackifier | | | | | | | |
| | Storage modulus (Pa) | | 3.2 × 10⁶ | 2.0 × 10⁶ | 4.4 × 10⁵ | 5.9 × 10⁵ | 6.7 × 10⁵ | 5.2 × 10⁵ |
| Second pressure- | Trade | Rubber-based | Tuftec | Tuftec | Tuftec | Tuftec | DYNARON | DYNARON |
| sensitive adhesive | name | resin component | H1062 | H1062 | H1041 | H1062 | 1320P | 1320P |
| layer | | Tackifier | — | ARCON P125 | ARCON P125 | ARCON P125 | ARCON P125 | ARCON P125 |

| | | | | | | |
|---|---|---|---|---|---|---|
| Rubber-based resin | 100/0 | 95/5 | 85/15 | 95/5 | 70/30 | 75/25 |
| component/Tackifier | | | | | | |
| Storage modulus (Pa) | 1.3 × 10⁶ | 4.5 × 10⁶ | 1.6 × 10⁶ | 4.5 × 10⁶ | 4.1 × 10⁵ | 4.2 × 10⁵ |

| | | | | | | |
|---|---|---|---|---|---|---|
| Adhesion (N/20 mm) | Not bonded | Not bonded | 0.012 | Not bonded | 0.086 | 0.07 |
| Prism sheet lens apex angle portion | 0 | 0 | 0.7 | 0.05 | 11.12 | 8.28 |
| indentation depth (μm) | | | | | | |
| Deformation of prism sheet lens | ∘ | ∘ | ∘ | ∘ | x | x |
| apex angle | | | | | | |
| Indentation | ∘ | ∘ | ∘ | ∘ | x | x |

As shown in Table 1, the pressure-sensitive adhesive tape of the present invention brings together sufficient pressure-sensitive adhesiveness for, and sufficient releasability from, a member having unevenness formed on its surface. In addition, the apexes of the uneven portion do not penetrate the pressure-sensitive adhesive layer, and hence the apexes do not reach the base material layer. Accordingly, it can be found that no deformation of the apexes occurs. It can also be found that the pressure-sensitive adhesive tape of the present invention brings together sufficient pressure-sensitive adhesiveness for, and sufficient releasability from, a prism sheet and does not cause indentation.

On the other hand, as shown in Tables 2 and 3, it can be found that, when only one pressure-sensitive adhesive layer is provided or when two pressure-sensitive adhesive layers are provided but a requirement of the pressure-sensitive adhesive tape of the present invention is not satisfied, compatibility between sufficient pressure-sensitive adhesiveness for, and sufficient releasability from, a member having unevenness formed on its surface cannot be achieved, the deformation of the apexes of the uneven portion occurs, compatibility between sufficient pressure-sensitive adhesiveness for, and sufficient releasability from, a prism sheet cannot be achieved, or indentation emerges.

### INDUSTRIAL APPLICABILITY

The pressure-sensitive adhesive tape of the present invention is such a pressure-sensitive adhesive tape as described below, which is capable of protecting the uneven surface of a member having unevenness on its surface. The pressure-sensitive adhesive tape brings together sufficient pressure-sensitive adhesiveness for, and sufficient releasability from, the member. In addition, even upon deformation of the member protected with the pressure-sensitive adhesive tape by, for example, lamination or continuous winding, the uneven shape does not deform and the base material layer in the pressure-sensitive adhesive tape is not damaged. Accordingly, the pressure-sensitive adhesive tape is suitable as a surface protective film for uneven members each provided with design by forming unevenness on its surface, the uneven members being used in the fields of, for example, automobiles and housing construction materials. In addition, the pressure-sensitive adhesive tape is suitable as a surface protective film capable of effectively protecting a lens surface of a prism sheet having multiple triangle pole-shaped prisms fixed on its surface.

### REFERENCE SINGS LIST

1 base material layer
21 first pressure-sensitive adhesive layer
22 second pressure-sensitive adhesive layer
100 pressure-sensitive adhesive tape
200 prism sheet

1. A pressure-sensitive adhesive tape, comprising:
a base material layer;
a first pressure-sensitive adhesive layer; and
a second pressure-sensitive adhesive layer in the stated order, wherein:
the base material layer contains a thermoplastic resin;
a storage modulus of the first pressure-sensitive adhesive layer is higher than a storage modulus of the second pressure-sensitive adhesive layer; and
a difference between a storage modulus of the first pressure-sensitive adhesive layer at a frequency of 10 Hz and 23° C., and a storage modulus of the second pressure-sensitive adhesive layer at a frequency of 10 Hz and 23° C. is 3×10⁵ Pa or more.

2. The pressure-sensitive adhesive tape according to claim 1, wherein the first pressure-sensitive adhesive layer has a storage modulus of 1.0×10⁶ Pa or more and less than 1.0×10⁹ Pa at a frequency of 10 Hz and 23° C.

3. The pressure-sensitive adhesive tape according to claim 1, wherein the second pressure-sensitive adhesive layer has a storage modulus of 1.0×10³ Pa or more and less than 1.0×10⁶ Pa at a frequency of 10 Hz and 23° C.

4. The pressure-sensitive adhesive tape according to claim 1, wherein a releasing layer is placed on a side of the base material layer opposite to the first pressure-sensitive adhesive layer and the second pressure-sensitive adhesive layer.

5. The pressure-sensitive adhesive tape according to claim 1, wherein the pressure-sensitive adhesive tape comprises a surface protective film for a prism sheet.
